(19) United States
(12) Patent Application Publication
(10) Pub. No.: US 2017/0046274 A1
(43) Pub. Date: Feb. 16, 2017

(54) EFFICIENT UTILIZATION OF MEMORY GAPS

(71) Applicant: QUALCOMM Incorporated, San Diego, CA (US)

(72) Inventors: Andres Alejandro OPORTUS VALENZUELA, San Diego, CA (US); Gurvinder Singh CHHABRA, San Diego, CA (US); Nieyan GENG, San Diego, CA (US); John BRENNEN, San Diego, CA (US); BalaSubrahmanyam CHINTAMNEEDI, San Diego, CA (US)

(21) Appl. No.: 14/827,255

(22) Filed: Aug. 14, 2015

(51) Int. Cl. G06F 12/10

(52) U.S. Cl. CPC G06F 12/1036; G06F 2212/50

(57) ABSTRACT

Systems and methods pertain to a method of memory management. Gaps are unused portions of a physical memory in sections of the physical memory mapped to virtual addresses by entries of a translation look-aside buffer (TLB). Sizes and alignment of the sections in the physical memory may be based on the number of entries in the TLB, which leads to the gaps. One or more gaps identified in the physical memory are reclaimed or reused, where the one or more gaps are collected to form a dynamic buffer, by mapping physical addresses of the gaps to virtual addresses of the dynamic buffer.

### FIELD OF DISCLOSURE

Disclosed aspects relate to memory management, and more particularly, exemplary aspects relate to reclaiming and efficient utilization of unused gaps in memory.

### BACKGROUND

A memory management unit (MMU) is used to perform address translation (and other memory management functions) for processors or peripheral devices. For example, an MMU may comprise a translation lookaside buffer (TLB) as known in the art to perform virtual to physical memory address translations. An MMU or TLB may include a limited number of entries, where each entry comprises a memory mapping (e.g., a virtual memory address mapped to a physical memory address) to aid in the translations.

The physical memory addresses pertain to a physical memory such as a random access memory (RAM). Each TLB entry can map to a section of physical memory. Since the number of TLB entries is limited, each section may span across more physical memory space than utilized by a particular program or application whose virtual addresses are mapped to physical addresses by a TLB entry. Each section can be a size which is a multiple (and specifically, a power-of-2) of a minimum granularity of physical memory space. For example, the section sizes may be 256 KB, 1 MB, etc., for a minimum granularity, wherein, the minimum granularity can be a small block size such as a 4 KB block. However, as noted above, not all of the physical memory space within a section is used. Therefore, a TLB entry which maps to a 256 KB section of the physical memory may only utilize 224 KB, for example, leaving 32 KB of unused memory in the 256 KB section. Conventional memory management designs do not use such unused memory spaces, which are also referred to as “gaps” in this disclosure.

Memory or storage space is an important hardware resource on semiconductor dies, especially with shrinking device sizes. Accordingly, it is desirable to avoid wastage of memory space caused by the gaps.

### SUMMARY

Exemplary embodiments of the invention are directed to systems and method for memory management. Gaps are unused portions of a physical memory in sections of the physical memory mapped to virtual addresses by entries of a translation look-aside buffer (TLB). Sizes and alignment of the sections in the physical memory may be based on the number of entries in the TLB, which leads to the gaps. One or more gaps identified in the physical memory are reclaimed or reused, where the one or more gaps are collected to form a dynamic buffer, by mapping physical addresses of the gaps to virtual addresses of the dynamic buffer.

For example, an exemplary aspect pertains to a of memory management, the method comprising identifying gaps in a physical memory, wherein the gaps are unused portions of the physical memory in sections of the physical memory mapped to virtual addresses by entries of a translation look-aside buffer (TLB), and collecting the gaps by mapping physical addresses of the gaps to virtual addresses of a dynamic buffer.

Another exemplary aspect relates to an apparatus comprising a physical memory. The physical memory comprises one or more gaps, wherein the one or more gaps are unused portions of the physical memory in sections of the physical memory mapped to virtual addresses by entries of a translation look-aside buffer (TLB). The apparatus further comprises a dynamic buffer comprising virtual addresses mapped to one or more gaps collected from the physical memory.

Yet another exemplary aspect is directed to a system comprising a physical memory comprising one or more gaps, wherein the one or more gaps are unused portions of the physical memory in sections of the physical memory mapped to virtual addresses by a means for mapping, and means for collecting at least a subset of the one or more gaps.

Another exemplary aspect is directed to a non-transitory computer-readable storage medium comprising code, which, when executed by a processor, causes the processor to perform operations for memory management, the non-transitory computer-readable storage medium comprising code for identifying one or more gaps in a physical memory, wherein the one or more gaps are unused portions of the physical memory in sections of the physical memory mapped to virtual addresses by entries of a translation look-aside buffer (TLB), and code for collecting at least a subset of the one or more gaps by mapping physical addresses of at least the subset of the gaps to virtual addresses of a dynamic buffer.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a conventional TLB.

FIG. 2 a physical memory configured according to aspects of this disclosure.

FIG. 3 illustrates a processing system configured according to aspects of this disclosure.

FIG. 4 illustrates a flow-chart pertaining to a method of memory management according to exemplary aspects.

FIG. 5 illustrates an exemplary processing device in which an aspect of the disclosure may be advantageously employed

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Exemplary aspects of this disclosure pertain to identifying gaps or unused memory spaces of a physical memory in sections of the physical memory that are mapped to by entries of a translation look-aside buffer (TLB) or memory management unit (MMU). The gaps are reclaimed or repurposed so that the memory space in the gaps can be utilized, rather than wasted. For example, a dynamic buffer can be created to collect the gaps, where physical addresses of the gaps can be mapped to virtual addresses in the dynamic buffer.

The gaps collected to form a dynamic buffer may not have contiguous physical addresses, which allows for greater flexibility in collecting the gaps. However, it will be understood that a single gap comprising a contiguous physical memory region can also be collected to form a dynamic buffer, for example, in cases where a dynamic buffer may be specified to include only an uninterrupted physical memory region.

In some aspects, gaps can be purposefully introduced in a physical memory, for example, by mapping TLB entries to larger sections in the physical memory. This creates more opportunities for gap collection, as well as reduces the number of TLB entries used to cover a physical memory space. In this manner, usable memory space of the physical memory is increased, since the previously unused memory in the gaps can be reused. Accordingly, memory budgets for processing applications can be increased. For example, memory constrained systems which have tight memory budgets due to limited availability of physical memory space can benefit from larger physical memory space made available from an existing physical memory, such as a RAM module, rather than resorting to adding additional RAM modules to meet the memory budgets.

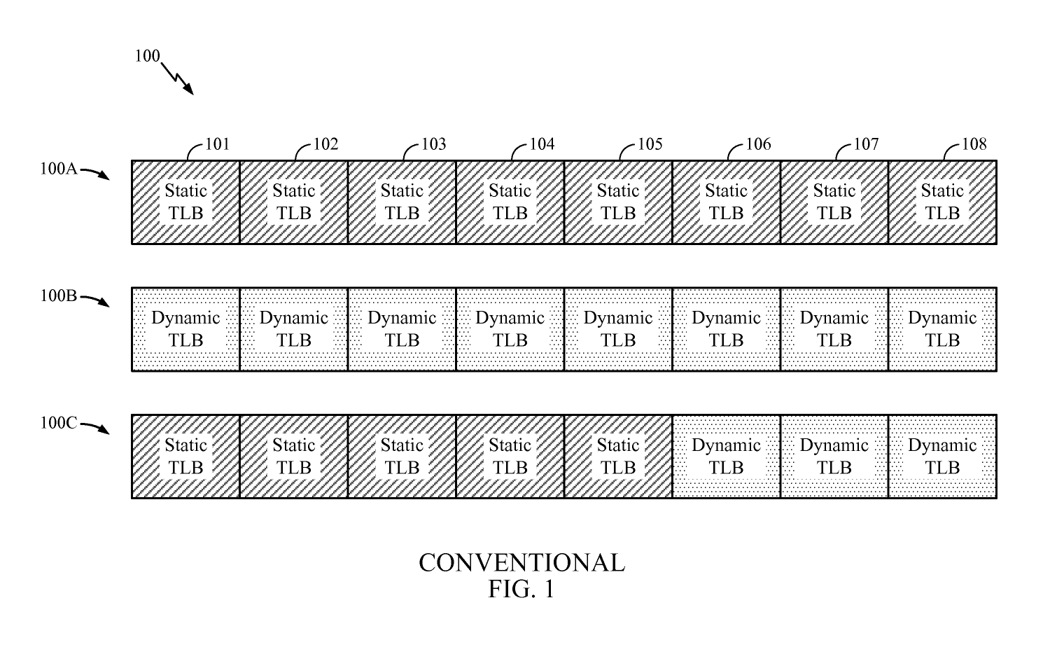

In order to further explain exemplary aspects of gap reclaiming, FIG. 1 will first be consulted for a brief background of dynamic/unlocked and static/locked TLB entries. In FIG. 1, three configurations, 100A, 100B, and 100C of a conventional TLB 100 are shown. TLB 100 may provide virtual-to-physical address translations for a processing system (not shown), where the physical addresses pertain to a physical memory (also, not shown). TLB 100 is shown to include 8 TLB entries, labeled 101-108 in FIG. 1.

In general, each TLB entry 101-108 can either be static/locked or dynamic/unlocked. A static/locked TLB entry has a mapping to a section of the physical memory which is locked or cannot be modified. A dynamic/unlocked TLB entry can have a mapping which is dynamic and can be changed (e.g., by an operating system).

Configuration 100A shows that all 8 TLB entries 101-108 are static/locked. Configuration 100A is designed for high performance of TLB 100, but configuration 100A may not have high flexibility. To explain further, mappings of all TLB entries 101-108 of configuration 100A are locked to particular segments of the physical memory, which means that the TLB entries 101-108 may not be updated (e.g., by an operating system), which in turn increases performance. For example, since various section sizes may be used by a particular application or program, a larger number of TLB entries may cover the entire physical memory space (or “image”) for the application in order to match the section sizes as closely as possible. However, since only a limited number of TLB entries are available, each TLB entry may map to a much larger section, thus creating gaps. In general, a smaller number of TLB entries may lead to more gaps being created.

Configuration 100B, on the other hand, has all 8 TLB entries 101-108 set to be dynamic/unlocked. In configuration 100B, it is possible to have more TLB entries than the 8 entries illustrated, as the dynamic/locked entries can be updated and more entries can be added. Accordingly, configuration 100B offers high flexibility for TLB 100, but may have lower performance. For example, the dynamic/unlocked entries may be updated frequently (e.g., by an operating systems), leading to changes in mappings, which may reduce performance. Dynamic/unlocked mappings can lead to smaller gaps since smaller mappings sizes (i.e., smaller sizes of sections which are mapped) can be used and the number of TLB entries can be increased to map to smaller sections.

Thus, while mapping to smaller sections may lead to the dynamic mapping being updated more frequently (e.g., configuration 100B), updates to the mappings (e.g., on TLB misses) can be reduced with the use of bigger mappings (e.g., configuration 100A), but with larger gaps.

Configuration 100C offers a trade-off between the above features of configurations 100A and 100B. In configuration 100C, some TLB entries (e.g., TLB entries 101-105, as shown), can be static/locked and the remaining TLB entries (e.g., TLB entries 106-108) can be dynamic/unlocked. Once again, more than 8 TLB entries may be formed in this configuration as well, since dynamic mappings are possible. Thus, the static/locked TLB entries can be used for sections of the physical memory which may be used in high performance applications, while the remaining portions of the physical memory can be flexibly mapped by dynamic/unlocked TLB entries. In exemplary aspects, at least some dynamic/unlocked TLB entries are used to map dynamic buffers to a physical memory space comprising collected gaps.

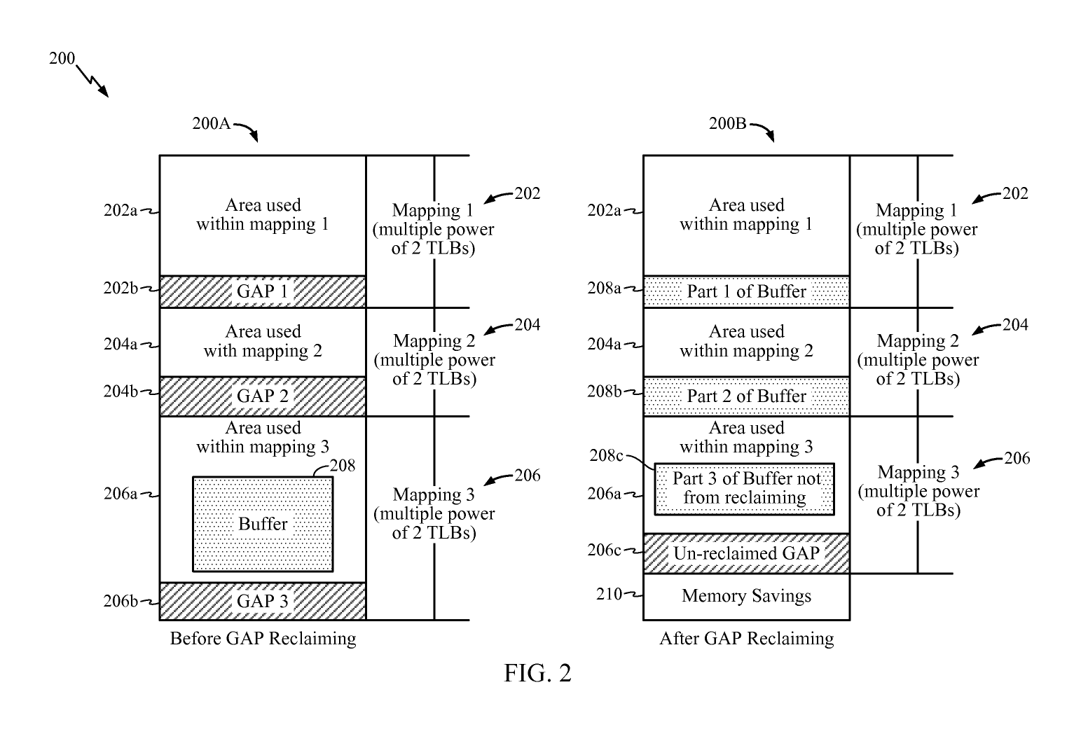

With reference now to FIG. 2, exemplary aspects of gap reclaiming for physical memory 200 will be explained. Physical memory 200 may be a random access memory (RAM) or the like and may be a cache or backing storage of a processing system (not shown). Virtual addresses used by the processing system may be translated to physical addresses of physical memory 200 by a TLB (such as TLB 100 in configuration 100C). Image 200A refers to physical memory 200 before gap reclaiming and image 200B refers to physical memory 200 after gap reclaiming is performed according to exemplary aspects.

Referring first to image 200A of physical memory 200, three sections 202, 204, and 206 are shown. Example first, second, and third TLB entries (not shown) may respectively map to sections 202, 204, and 206 of physical memory 200. Only area 202a may be mapped in section 202 by the first TLB entry (e.g., for a range of virtual addresses that a particular translation in the first TLB entry covers). However, the mapping for the first TLB entry may have been expanded to section 202, to align section 202 with predefined section boundaries or section sizes, for example, based on a given number of TLB entries. Thus, gap 202b in section 202 is left unused. Similarly, areas 204a and 206a of sections 204 and 206 are used by mappings in the second and third TLB entries, respectively, while gaps 204b and 206b remain unused.

In image 200A, buffer 208 is shown in section 206, and more specifically in area 206a. Buffer 208 can comprise physical memory which maps to virtual memory of a dynamic buffer (e.g., pertaining to a “heap” as known in the art). While buffer 208 is shown to comprise a contiguous block of physical memory in image 200A, a dynamic buffer can be formed from contiguous/uninterrupted physical address space or from non-contiguous physical memory sections. However, for buffer 208 to be mapped by a TLB entry, a certain minimum granularity (e.g., 4 KB block size) of the non-contiguous physical address spaces may be present in buffer 208.

Referring now to image 200B, exemplary gap collection to form buffer 208 is illustrated. Rather than confine buffer 208 to area 206a as in image 200A, physical memory from gaps 202b and 204b are collected to form buffer 208. In other words, physical memory of buffer 208 is spread across three parts in this example. Gap 202b is reclaimed to form part 208a of buffer 208. Similarly, gap 204b is reclaimed to form part 208b of buffer 208. The remaining part 208c of buffer 208 is retained within section 206, but the size of the area used in section 206 is reduced from area 206a by an amount corresponding to area 210, which will be explained below.

Furthermore, not all gaps may be reclaimed in some cases, and as illustrated, some or all of gap 206b may remain un-reclaimed. For example, despite gap collection to form buffer 208, a portion of gap 206b may remain un-reclaimed, wherein the un-reclaimed portion of gap 206b has been identified as un-reclaimed gap 206c in image 200B. In exemplary aspects, un-reclaimed gap 206c may remain (or may be moved) towards the end of section 206. A new section (not shown) may be formed to comprise un-reclaimed gap 206c in some cases.

By reclaiming the gaps, as above, to form buffer 208, it is seen that area 210 of physical memory 200 can now be freed up from current TLB mappings, thus making area 210 available to future TLB entries. Area 210 represents memory savings, as more memory space has now been made available, which can be utilized.

Reclaiming physical memory from gaps 202b and 204b to form buffer 208 can involve altering the mappings for corresponding virtual memory addresses in the TLB. For example, dynamic/unlocked TLB entries (e.g., TLB entries 106-108 of configuration 100C of TLB 100 in FIG. 1) can be used to map virtual addresses of a dynamic buffer to the physical addresses of buffer 208. To form buffer 208 from reclaimed gaps in image 200B, the mappings can be modified such that the virtual addresses map to physical addresses of gaps 202b and 204b. Dynamic/unlocked TLB entries provide higher flexibility for modify the mappings to reclaim gaps. It is noted, however, that static/locked TLB entries can also be used in reclaiming gaps, but using static/locked TLB entries may consume a larger number of TLB entries, making static/locked TLB entries a less desirable or less suitable choice for gap reclaiming.

In exemplary aspects, the regions of physical memory 200 covered by gaps 202b and 204b, for example, which are used for gap collection, can be smaller in comparison to other sections mapped by TLB entries; gap reclaiming can use the smallest memory sizes that can be mapped by TLBs, such as granularities of 4 KB blocks, such that the number of gaps that can be reclaimed can be maximized.

From the above discussion, it is also seen that exemplary gap reclaiming can avoid or minimize wastage of memory space, and even result in savings (e.g., area 210 of physical memory 200). Thus, in some aspects, not only are existing gaps utilized efficiently, but also, one or more gaps can be introduced on purpose in a physical memory space. Purposefully introducing gaps can lead to bigger sections which can be mapped by TLB entries (thus reducing the number of TLB entries which are used to cover a given image or physical memory space). For example, if gap 202b did not already exist in section 202 in image 200A, then gap 202b can be purposefully introduced in order to align boundaries of section 202 to desirable boundaries or sizes (e.g., to cover a memory space which is a power-of-2 multiple of the smallest granularity which can be mapped, such as a power-of-2 multiple of a 4 KB block).

Introducing new gaps in a memory image such as image 200A, can lead to a new image, wherein the number of TLB entries which map to sections of the new image can be reduced. Correspondingly, hardware and associated costs of the TLB can also be reduced. Further, with a reduced number of TLB entries, effects such as dynamic mapping trashing (e.g., where changing mappings of certain sections can undesirably override prior mappings) of the sections can be minimized.

Furthermore, introducing new gaps in image 200A to form a new image can also lead to creation of new sections in physical memory 200. Hardware costs associated with creation of new sections based on reclaiming gaps (wherein, the gaps may be purposefully introduced) is seen to be reduced, because of the reduced number of TLB entries. Thus, in some aspects, introducing gaps can lead to minimizing the TLB costs and usage.

Exemplary gap collection can be used for implementing dynamic buffers such as “heaps,” which are known in the art. Heaps are dynamic buffers (e.g., which map to physical addresses of buffer 208). Heaps can be composed of a number of virtual memory blocks. Heaps or other dynamic buffers map to a number of physical addresses. Some heaps may be allocated a range of contiguous physical addresses (e.g., when hardware solutions are used for allocating physical addresses to the heaps), where gaps may be collected and mapped to one virtual address range in a dynamic buffer which can be used to form a heap. Some implementations of heaps are not restricted to contiguous physical addresses, and so gaps can be collected and mapped to virtual addresses of the heaps. Some heaps can be allocated with a certain physical address space at the time of their creation, where a portion of the heap may be composed of reclaimed gaps and the remainder of the allocated physical address space can be composed of memory space which was not reclaimed from gaps. Thus, heaps and other dynamic buffers can be formed fully or partially from gaps, in exemplary aspects.

In exemplary aspects, some gaps may be compatible with a dynamic buffer, while some gaps may not be compatible. Thus, only gaps which are compatible with a dynamic buffer (which may be a subset of all available gaps) may be reclaimed for forming the dynamic buffer. Compatibility may be based on several criteria. In one example, compatibility of gaps which can be reclaimed to form a dynamic buffer may be based on read/write compatibility. Different read/write (RW) permissions may be associated with different sections of an image or physical memory space. For example, section 202 of physical memory 200 may have read-only (RX) permissions, whereas section 204 may have both read and write (RW) permissions. Thus, gap 202b of section 202 may not be compatible for use in software programs which specify both read and write permissions, but gap 202b can be compatible for forming dynamic buffers which store data associated with read-only permissions. Thus, gap 202b can be reclaimed to form the dynamic buffer compatible with read-only permissions. On the other hand, gap 204b of section 204 may be compatible with the software programs which specify both read and write permissions. Therefore, gap 204b may be reclaimed for the software programs which specify both read and write permissions.

Accordingly, it is seen that exemplary aspects of gap reclaiming can lead to reduced costs of processing systems on which they are deployed (since physical memory savings are possible, e.g., the size of physical memory 200 can be reduced by an amount given by area 210). Dynamic/unlocked TLB entries can be used to map to dynamic buffers formed from reclaimed gaps, which means that number of TLB misses can be reduced (since previously unused gaps can now be reclaimed and utilized), thus improving performance and reducing power consumption. By purposefully introducing gaps, new mappings and better control on section sizes or section alignment to desired section boundaries can be achieved, leading to lower numbers of TLB entries and smaller TLB sizes. Further, since gaps can be introduced to control section sizes, the overall build size (i.e., size of the memory image) can be controlled, wherein a substantially constant build size can be maintained without significant variation.

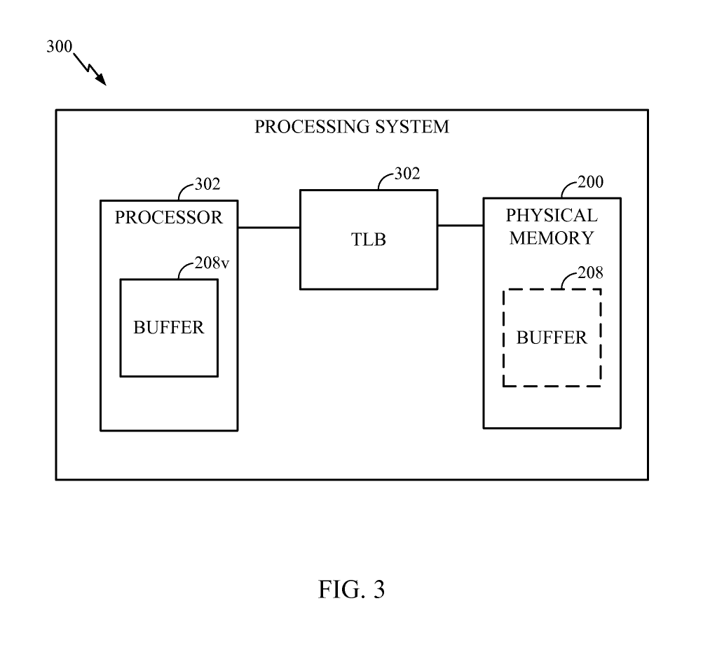

With reference now to FIG. 3, an example processing system 300 configured according to exemplary aspects is illustrated. Processing system 300 can be an apparatus which comprises means for implementing the functionality described herein. For example, processing system 300 can include processor 302 (which may be a general purpose processor or a special purpose processor, such as a digital signal processor (DSP), for example). Processor 302 may include logic or functionality to execute programs which use virtual or logical addresses.

Processing system 300 can include physical memory 200 discussed in relation to FIG. 2, wherein physical memory 200 can be a means for storing. Gaps of physical memory 200 can be reclaimed (represented by buffer 208 shown in dashed lines to indicate that the physical memory of buffer 208 may not be contiguous. TLB 304 may be memory management unit or other means for mapping virtual addresses used by processor 302 to physical addresses of physical memory 200. Physical memory 200 may comprise sections (e.g., 202, 204, 206) as discussed above, where sizes and alignment of the sections may be based on the number of entries of TLB 302. The entries of TLB 304 can be static/locked or dynamic/unlocked (as discussed with reference to FIG. 1). The TLB entries can be mapped to the sections of physical memory 200. The sections of physical memory 200 may comprise gaps (e.g., 202b, 204b, 206b), which are unused portions of the physical memory in the sections.

Processing system 300 can comprise means for collecting the gaps of physical memory 200. For example, buffer 208v shown in processor 302 may be a dynamic buffer whose virtual addresses are mapped to physical addresses of buffer 208. As such, buffer 208v can comprise means for collecting the gaps (e.g., 202b and 204b) in physical memory 200.

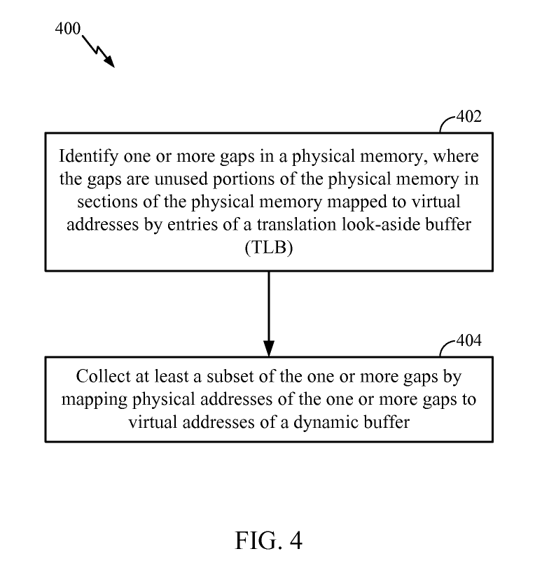

It will also be appreciated that exemplary aspects include various methods for performing the processes, functions and/or algorithms disclosed herein. For example, FIG. 4 illustrates method 400 of memory management (e.g., of physical memory 200).

As shown in Block 402, method 400 comprises identifying one or more gaps in a physical memory, wherein the one or more gaps are unused portions of the physical memory in sections of the physical memory mapped to virtual addresses by entries of a translation look-aside buffer (TLB). For example, Block 402 can relate to identifying gaps 202b, 204b, and 206b in physical memory 200 in sections 202, 204, and 206 mapped by TLB 304.

In Block 404, method 400 comprises collecting at least a subset of the one or more gaps by mapping physical addresses of the one or more gaps to virtual addresses of a dynamic buffer. For example, in Block 404, gaps 202b, 204b, and 206b can be collected to form dynamic buffer 208v mapped to parts 208a, 208b, and 208c of buffer 208.

As seen in method 400, the gaps can be collected from at least two different sections (e.g., sections 202, 204, 206) of the physical memory, and at least two gaps (e.g., 202b, 204b) can be non-contiguous in the physical memory. The sizes and alignment of the sections in the physical memory can be based on the number of entries in the TLB. In further aspects of method 400, at least one gap (e.g., 202b) can be introduced in at least one section (e.g., section 202). The number of entries of the TLB can be reduced by introducing gaps in this manner. Method 400 can further include mapping physical addresses of the gaps to virtual addresses of the dynamic buffer using one or more dynamic/unlocked TLB entries.

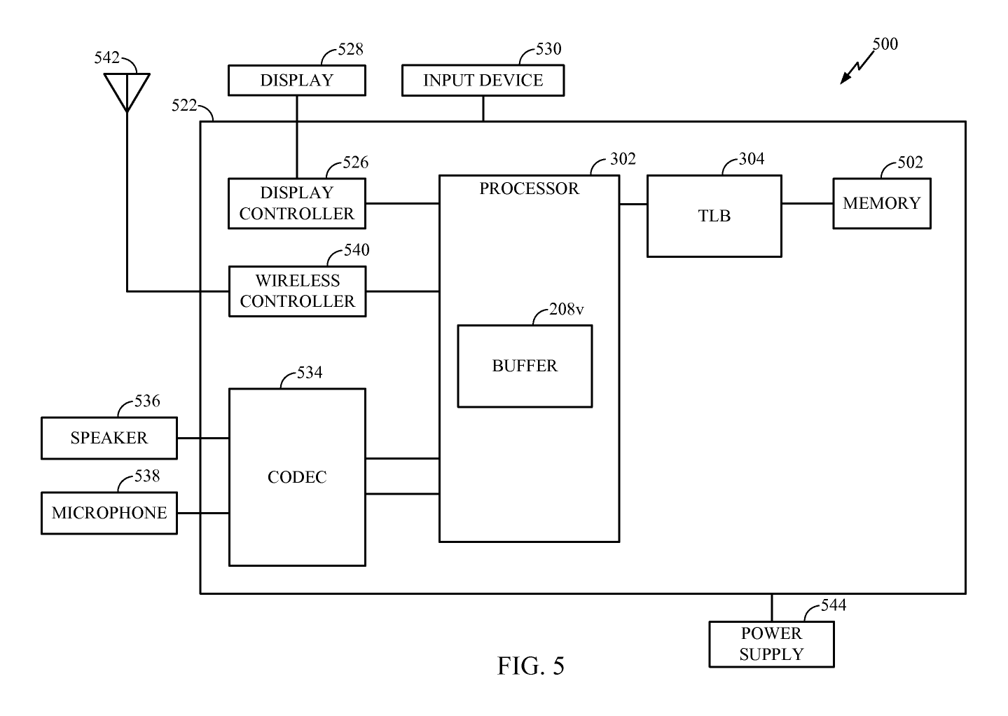

FIG. 5 shows a block diagram of processing device 500 that is configured according to exemplary aspects. In some aspects, processing device 500 may be configured as a wireless device. Processing device 500 can include some similar aspects discussed with reference to processing system 300 of FIG. 3. Processing device 500 can also be configured to implement the processes described with reference to method 400 of FIG. 4. As shown, processing device 500 includes processor 302, which can be, for example, a digital signal processor (DSP) or any general purpose processor or central processing unit (CPU) as known in the art. Dynamic buffer 208v in processor 302 and TLB 304 discussed in FIG. 3 are also shown. Processor 302 may be communicatively coupled to memory 502, for example, via TLB 304, wherein memory 502 can comprise physical memory 200 described previously.

FIG. 5 also shows display controller 526 that is coupled to processor 302 and to display 528. Coder/decoder (CODEC) 534 (e.g., an audio and/or voice CODEC) can be coupled to processor 302. Other components, such as wireless controller 540 (which may include a modem) are also illustrated. Speaker 536 and microphone 538 can be coupled to CODEC 534. FIG. 5 also indicates that wireless controller 540 can be coupled to wireless antenna 542. In a particular aspect, processor 302, display controller 526, memory 502, CODEC 534, and wireless controller 540 are included in a system-in-package or system-on-chip device 522.

In a particular aspect, input device 530 and power supply 544 are coupled to the system-on-chip device 522. Moreover, in a particular aspect, as illustrated in FIG. 5, display 528, input device 530, speaker 536, microphone 538, wireless antenna 542, and power supply 544 are external to the system-on-chip device 522. However, each of display 528, input device 530, speaker 536, microphone 538, wireless antenna 542, and power supply 544 can be coupled to a component of the system-on-chip device 522, such as an interface or a controller.

It should be noted that although FIG. 5 depicts a wireless communications device, processor 302 and memory 502, may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for utilizing gaps in a physical memory. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of memory management, the method comprising:
identifying one or more gaps in a physical memory, wherein the one or more gaps are unused portions of the physical memory in sections of the physical memory mapped to virtual addresses by entries of a translation look-aside buffer (TLB); and
collecting at least a subset of the one or more gaps by mapping physical addresses of at least the subset of the gaps to virtual addresses of a dynamic buffer.

2. The method of claim 1, comprising collecting at least the subset of the one or more gaps from at least two different sections of the physical memory.

3. The method of claim 1, wherein sizes and alignment of at least the two different sections of the physical memory are based on a number of entries in the TLB.

4. The method of claim 1, further comprising introducing at least one new gap in at least one section of the physical memory.

5. The method of claim 4 comprising reducing a number of entries of the TLB.

6. The method of claim 1, wherein at least two of at least the subset of the gaps are non-contiguous in the physical memory.

7. The method of claim 1, comprising performing the mapping of the physical addresses of at least the subset of the gaps to virtual addresses of the dynamic buffer in one or more dynamic/unlocked TLB entries.

8. An apparatus comprising:
a physical memory comprising one or more gaps, wherein the one or more gaps are unused portions of the physical memory in sections of the physical memory mapped to virtual addresses by entries of a translation look-aside buffer (TLB); and
a dynamic buffer comprising virtual addresses mapped to at least a subset of the one or more gaps collected from the physical memory.

9. The apparatus of claim 8, wherein at least the subset of the one or more gaps collected from the physical memory belong to at least two different sections of the physical memory.

10. The apparatus of claim 8, wherein sizes and alignment of at least the two different sections in the physical memory are based on the number of entries in the TLB.

11. The apparatus of claim 8, wherein at least one new gap is purposefully introduced in at least one section.

12. The apparatus of claim 8, wherein at least two of at least the subset of the one or more gaps are non-contiguous in the physical memory.

13. The apparatus of claim 8, wherein the TLB comprises one or more dynamic/unlocked TLB entries to map virtual addresses of the dynamic buffer to physical addresses of the one or more gaps collected from the physical memory.

14. The apparatus of claim 8, integrated into a device selected from the group consisting of a set top box, music player, video player, entertainment unit, navigation device, communications device, personal digital assistant (PDA), fixed location data unit, and a computer.

15. A system comprising:
means for storing, comprising one or more gaps, wherein the one or more gaps are unused portions of the means for storing in sections of the means for storing mapped to virtual addresses by a means for mapping; and
means for collecting at least a subset of the one or more gaps.

16. A non-transitory computer-readable storage medium comprising code, which, when executed by a processor, causes the processor to perform operations for memory management, the non-transitory computer-readable storage medium comprising:
code for identifying one or more gaps in a physical memory, wherein the one or more gaps are unused portions of the physical memory in sections of the physical memory mapped to virtual addresses by entries of a translation look-aside buffer (TLB); and
code for collecting at least a subset of the one or more gaps by mapping physical addresses of at least the subset of the gaps to virtual addresses of a dynamic buffer.

17. The non-transitory computer-readable storage medium of claim 16, comprising code for collecting at least the subset of the one or more gaps from at least two different sections of the physical memory.

18. The non-transitory computer-readable storage medium of claim 16, further comprising code for introducing at least one new gap in at least one section of the physical memory.

19. The non-transitory computer-readable storage medium of claim 18 comprising code for reducing a number of entries of the TLB.

20. The non-transitory computer-readable storage medium of claim 16, comprising code for performing the mapping of the physical addresses of at least the subset of the gaps to virtual addresses of the dynamic buffer in one or more dynamic/unlocked TLB entries.
